(19) United States
(12) Patent Application Publication
(10) Pub. No.: US 2015/0080027 A1
(43) Pub. Date: Mar. 19, 2015

(54) METHOD FOR GROUP SOCIAL SUGGESTIONS BASED ON SPATIAL DATA AND SHARED PREFERENCES

(71) Applicant: International Business Machines Corporation, Armonk, NY (US)

(72) Inventors: Dustin K. Amrhein, Zachary, LA (US); Kulvir S. Bhogal, Fort Worth, TX (US); Nitin Gaur, Round Rock, TX (US); Todd E. Kaplinger, Raleigh, NC (US)

(73) Assignee: International Business Machines Corporation, Armonk, NY (US)

(21) Appl. No.: 14/031,503

(22) Filed: Sep. 19, 2013

(51) Int. Cl. H04W 4/02

(52) U.S. Cl. CPC H04W 4/02
USPC 455/456.3

(57) ABSTRACT

A method and system for managing a group activity using electronic communications includes joining a plurality of users to form a proximity based network. Data is received and accessed from the plurality of users each using a mobile device configured to communicate with the proximity based network on the communications network. The data includes location information and personal information. A multiplicity of social connections are defined between the users based on the data. A set of the plurality of users are identified wherein at least two of the mobile devices are within the predetermined proximity, and the corresponding users have a shared social connection, A proposed activity is defined for the set of the users based on the shared social connection. The set of users of the proposed activity are notified.

### BACKGROUND

1. Field

The present disclosure relates to a method and system for managing a group activity using electronic communications, and more particularly, includes matching shared interests and location information in forming a social network or group.

2. Background of the Disclosure

Users of electronic devices can share information with other users and interact with the world around them via various communications networks. Based on a user's location and preferences, a user can find events, restaurants, and other social activities in a current location of the user, or a planned location. The systems that provide these services are typically tailored to an individual, searching there own location, a desired location, or a friend's location.

### SUMMARY

The present invention, for example, in one embodiment, can be directed to system that can provide an individual with a technique of forming a network or group for engaging in social activities together. The system can make recommendations for activities based on shared preferences. The system can identify a group of users in close proximity at real time, and then make a suggestion for a proximate activity in which the group is likely to have a shared interest.

According to an aspect of the invention, a method for managing a group activity using electronic communications includes the steps of joining a plurality of users to form a proximity based network based on a request from each of the plurality of users. The proximity based network is hosted on a computer and accessible via a communications network. Data is received and accessed from the plurality of users each using a mobile device being configured to communicate with the proximity based network on the communications network. The data includes location information and personal information. A predetermined proximity is defined between the mobile devices for each of the users. A multiplicity of social connections are defined between the users based on the data. A set of the plurality of users are identified wherein at least two of the mobile devices are within the predetermined proximity, and the corresponding users having a shared social connection. A proposed activity is defined for the set of the users based on the shared social connection. The set of users of the proposed activity are notified, and at least one of the above steps is performed using a program executable by a processor of a computer.

In another aspect according to the invention, a computer program product for managing a group activity using electronic communications comprises a computer readable storage device having program code embodied therewith. The program code is readable/executable by a processor to perform a method, comprising the steps of: joining a plurality of users to form a proximity based network based on a request from each of the plurality of users, the proximity based network being hosted on a computer and accessible via a communications network; receiving and accessing data from the plurality of users each using a communications device being configured to communicate with the proximity based network on the communications network, the data including location information and personal information; defining a predetermined proximity between the communications devices for each of the users; defining a multiplicity of social connections between the users based on the data; identifying a set of the plurality of users wherein at least two of the communications devices are within the predetermined proximity, and the corresponding users having a shared social connection; defining a proposed activity for the set of the users based on the shared social connection; and notifying the set of users of the proposed activity, wherein at least one of the above steps is performed using a program executable by a processor of a computer.

In another aspect according to the invention, a system for managing a group activity using electronic communications, includes a communications device configured to receive and access data from a plurality of users each using a communications device. The communications devices being configured to communicate with a proximity based network on a communications network. The data includes location information and personal information, the proximity based network formed using the plurality of users based on a request from each of the plurality of users, and the proximity based network being hosted on a computer and accessible via a communications network. A computer program is embodied on a computer readable storage device and executable by a processor of the computer. The communications device is configured to communicate with the computer, the computer program having program modules having code/instruction for: defining a predetermined proximity between the communications devices for each of the users; defining a multiplicity of social connections between the users based on the data; identifying a set of the plurality of users wherein at least two of the communications devices are within the predetermined proximity, and the corresponding users having a shared social connection; defining a proposed activity for the set of the users based on the shared social connection; and notifying the set of users of the proposed activity, wherein at least one of the above steps is performed using a program executable by a processor of a computer.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 is a schematic block diagram illustrating an overview of the system and methodology for managing a group activity using electronic communications according to an embodiment of the disclosure; and

FIG. 2 is a flow chart illustrating a method for managing a group activity using electronic communications using the system of FIG. 1 according to an embodiment of the disclosure.

### DETAILED DESCRIPTION

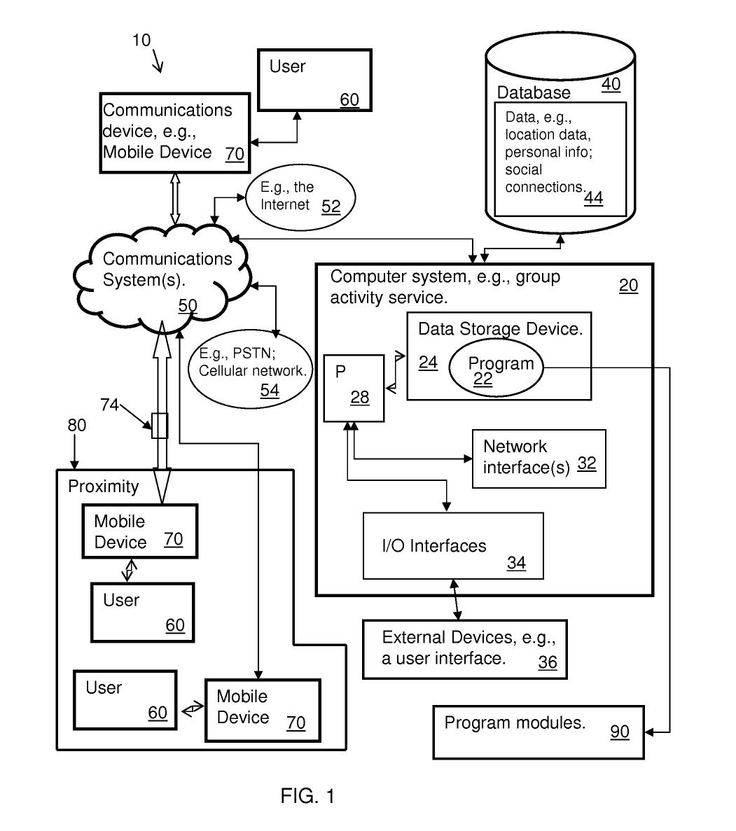

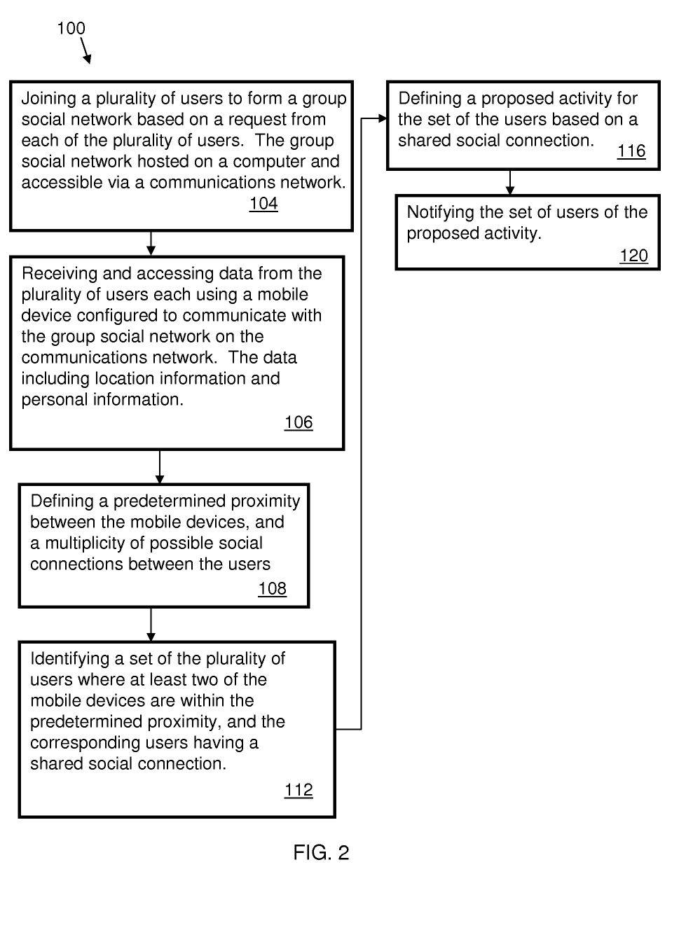

Referring to FIGS. 1-2 a system 10 and method 100 for managing a group activity using electronic communications is described in detail below. Step 104 includes joining a plurality of users to form a proximity based network or group based on a request from each of the plurality of users. Step 104 further includes receiving location information from the plurality of users which each have a communications device. The users 60 shown in FIG. 1 are representative of a plurality of users which may include, for example, several users or dozens or even hundreds of user. Each of the users 60 have access to a communication device, for example, a mobile device 70 which generically represents a communications device including one or more mobile devices which can communicate with each other and a communications system. For example, communications devices can include: a computer, or Personal Data Assistant (PDA), notebook, a tablet, a cell phone, or other mobile device, a laptop, a netbook, or a car communication system. The mobile devices 70 can send an electronic message, such as a text or an email. An electronic message is generically represented at message 74 in FIG. 1, which may include a text message, or an email message, or a message thread of considerable length between multiple users.

Step 106 includes receiving and accessing data from the plurality of users each using a mobile device which is configured to communicate with the proximity based network on the communications network. The data 44 can include location information and personal information which can be stored, for example, in a database 40. The location information can include the device location and thereby the user location, and can be sent or ascertained from each of the mobile devices 70. The location data can be requested by the system or provided by the mobile devices.

The personal information can include, for example, common recreational activities, shared food interest, similar volunteer causes, or any number of social activities. Personal information can be acquired, for example, querying the social history of each user, accessing email messages, or contact lists, and accessing other social forums, to determine activities, preferences, and contacts. Frequency or types of social communications and interactions can also be ascertained and weighted to indicate more frequency or a closer social interaction than other types of communication. For instance, direct communications via emails can have a higher weight than passive interaction such as being on a contact list for a broadcast communication.

The users 60 may send the message 74 using their mobile devices, and the location data may be provided, using a communications system, e.g., messaging system 50 that can include, the Internet 52, or a public switched telephone network (PSTN) for example, a cellular network 54. The PSTN may include telephone lines, fiber optic cables, microwave transmission links, cellular networks, and communications satellites. Exemplary messaging services may include Short Message Service (SMS) which is a text messaging service component of phone, web, or mobile communication systems, using standardized communications protocols which allows the exchange of short text messages between fixed line or mobile phone devices. The Internet may facilitate numerous texting techniques, for example, using a cell phone or laptop computer to send text messages via Multimedia Messaging Service (MMS) (related to SMS) as one technique to send messages that include multimedia content to and from mobile phones, or to and from one or more email accounts via the Internet.

The messages 74 sent by the users 60, and the location data may be stored in a database 40 which stores data 44 of a computer system 20. The computer system can be part of a group activity service for providing the method disclosed herein as a service. The method 100 may be embodied in a program 22 embodied on a computer readable storage device, e.g., data storage device 24, and is executable by a processor 28 of the computer 20 (i.e., execute program steps, code, or program code). The program or executable instructions therefrom, may be offered as a service by a provider. The program may also be stored and run locally on a user device. The computer 20 and program 22 shown in FIG. 1 are generic representations of a computer and program that may be local to a user, or provided as a remote service, such as a website accessible using the Internet. The computer 20 also generically represent herein a computer device such a personal data assistant, a laptop, or desktop computer, etc., or part of one or more servers, alone or as part of a datacenter. The computer system 20 can include a network interface 32, and input/output (I/O) interface(s) 34. The I/O interface 34 allows for input and output of data with an external device 36 that may be connected to the computing device. The network interface 32 may provide communications between the computing device and a computer network.

The program 22 may include program modules 90 for executing specific steps, routines, sub-routines, instructions or code, of the program. Such modules 90 are generically represented in FIG. 1.

Step 108 includes defining a predetermined proximity 80 (or a proximate location) between the mobile devices 70, and thereby their users, and a multiplicity of possible social connections between the users. The predetermined proximity 80 may be a defined location, or a location between or proximal to two or more users. The location can be determined from a landmark or one of the users, or a radius from a landmark or a user. The location can also be determined by a distance or time of travel between the users. The predetermined proximity 80 is generically represented in FIG. 1 as the proximity 80. The predetermined proximity may be defined as a city, or a certain area of a city. Thus, the predetermined proximity, can include, for example, a city, a town, a radius from a landmark, or a defined land area.

The multiplicity of possible social connections can be determined by the program 22 and is represented by program module 90 in FIG. 2. The possible social connections are represented by data 44 shown in FIG. 1 and can include preferences of each of the users. Social connections can include common interests, common places or locations to visit. This data can be voluntarily contributed by the users, or automatically extracted from the users, such as accumulated from the location of the user's device, or extracted from social media websites. The social connections may be selected from a group which includes: a social network connection, an email, instant messages (IM), mutually attending an event, a mutual activity, a common interest, or a common interest or like.

Step 112 includes identifying a set of the plurality of users wherein at least two mobile devices are within the predetermined proximity, and the corresponding users have one or more shared social connections. In the embodiment of the disclosure shown in FIG. 1, the users 60 shown within the predetermined proximity 80 constitute a set.

Step 116 includes determining a proposed activity for the set of the users based on a shared social connection. The proposed activity or recommendation(s) can be an activity which is identified as being expected to be of interest to the set of users based on the one or more shared social connections. The social connection may be selected from a group of social connections, which may include: a social network connection; a direct interaction, for example, communicating via email, or instant messages (IM); attending an event; an activity, for example, eating in a restaurant; a common interest, for example, a community service event, a charity, a religion, political interests; or a similar preference or interest, for example, preferring to eat a particular food, food group, or type of food, or frequenting restaurants with a certain type of food. Thereby, determining a proposed activity for suggestion can include mining information about each user, which can be extracted from each user and their social connection. For instance, as described above, information can be mined using shared social connections to find and correlate common preferences, for example, interests and activities. The proposed activity or recommendation of step 116 can be determined from the above.

Step 120 includes notifying the set of users of the proposed activity. The notification can be provided by a notification or indication on the users' mobile devices of the proposed activity. The notification (or indication) may include, for example, a name, directions, an address, or a symbol indicating that a set of users for a proposed activity has been identified. The notification technique or mechanism may be selected from a group, including: an instant message (IM), a short message service (SMS), a post in a group chat or a social forum, or an email.

When the method 100 above is provided as an activity suggestion service, the method may further include allowing users to register a mobile device for the activity suggestion service. The registration may also include user registration which can include inputting data about the user and/or the user allowing the method to access one or more web based social accounts. The method 100 as an activity suggestion service may be website based and accessible by the mobile devices for the plurality of users.

The method 100 may further include searching within a second predetermined proximity for a location for an identified activity. Thereby, after the method 100 has determined a proposed activity for a set of users, and notified the users, the method can suggest a location for a common social connection.

Thereby, the embodiments of the disclosure as discussed above provide a method and system for forming groups to enjoy social activities together by providing recommendations for activities based on shared preferences between users. The method and system of the present disclosure identifies a group of users and determines that the group is socially acquainted. Then, the system uses the social history of each individual and the group to build a list of shared preferences. The system then can cross-reference the shared preferences with known events proximal to the location of the group.

Thus, in one embodiment of the disclosure, the system and method disclosed herein forms a proximity based network, within or close to a determined locale, and determines a set of users (which can be also referred to as determining friendships) by querying the social history of each member of the group and comparing the social history to find common interest (or points of interaction). The method can query social forums, emails and SMS messages exchanged between users/people, and build knowledge of activities each user has an interest in. The method can then compose a list of activities for the group that all members are likely to enjoy by comparing social history data with list of activities from each user. The list of activities can be cross references with nearby activities (which can be close to or within a define locale, or at a location). The method according to the present disclosure sends the suggested activities (e.g., via SMS, or email) to each member of the proximity based network.

Thus, the present disclosure can be embodied as a service or a centralized system embodied, for example, as a Group Suggestion Controller (GSC). The GSC registers smart devices of users which registrations are stored in a central database. The GSC can pursue building friendship domains or groups among all registered users. The GSC queries social data history using publicly available social networks, emails, and messages (providing it has user consent) to find friendship indicators. Each friendship indicator can have a different weight so that direct communication, like email, is a higher indicator of friendship than passive social interaction like a passive social forum.

Once friendship domains/groups are established, the GSC can inquire about shared preferences among the group. This can include common recreational activities, shared food tendencies, or any number of social activities. Similar to the friendship information, this information can be determined by querying the social history of each user to determine activities that the user has often shown a positive sentiment toward. The GSC can then determine a commonality list for the friendship domain/group. Users' devices can send updates about their location to the GSC by using a device's geo-location capabilities. The GSC can use this information to continually look for a group (of two or more users) of users in the friendship domain that are proximate to each other. When a group is found, the GSC consults the list of shared preferences for that group and matches that list with events and attractions near the group's current location. If there is a match between the shared preferences of the group and nearby attractions, the GSC sends each member of the group a notification, e.g., a message, such as, an SMS or email message, notifying the users that friends are close by and likely attractions they could be of interest to the group.

While embodiments of the present invention has been particularly shown and described with respect to preferred embodiments thereof, it will be understood by those skilled in the art that changes in forms and details may be made without departing from the spirit and scope of the present application. It is therefore intended that the present invention not be limited to the exact forms and details described and illustrated herein, but falls within the scope of the appended claims.

Therefore, one or more Figures described herein may illustrate a schematic of an embodiment of the disclosure and may include a representative computer system or processing system that may implement a method and a program in one or more embodiments of the present disclosure. The computer system is only one example of a suitable processing system and is not intended to suggest any limitation as to the scope of use or functionality of embodiments of the methodology described herein. The processing system shown may be operational with numerous other general purpose or special purpose computing system environments or configurations. Examples of well-known computing systems, environments, and/or configurations that may be suitable for use with one or more processing systems in the present disclosure may include, but are not limited to, personal computer systems, server computer systems, handheld or laptop devices, multiprocessor systems, microprocessor-based systems, programmable consumer electronics, network PCs, minicomputer systems, mainframe computer systems, and distributed cloud computing environments that include any of the above systems or devices, and the like.

The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices.

The components of computer system may include, but are not limited to, one or more processors or processing units, a system memory, and a bus that couples various system components including system memory to processor. Computer system may include a variety of computer system readable media. Such media may be any available media that is accessible by computer system, and it may include both volatile and non-volatile media, removable and non-removable media. System memory 58, shown in FIG. 1, can include computer system readable media in the form of volatile memory, such as random access memory (RAM) and/or cache memory or others. Computer system may further include other removable/non-removable, volatile/non-volatile computer system storage media. By way of example only, storage system 18 can be provided for reading from and writing to a non-removable, non-volatile magnetic media (e.g., a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 14 by one or more data media interfaces.

Computer system may also communicate with one or more external devices such as a keyboard, a pointing device, a display, etc.; one or more devices that enable a user to interact with computer system; and/or any devices (e.g., network card, modem, etc.) that enable computer system to communicate with one or more other computing devices. Such communication can occur via Input/Output (I/O) interfaces. Additionally, computer systems can communicate with one or more networks such as a local area network (LAN), a general wide area network (WAN), and/or a public network (e.g., the Internet) via network adapter. As depicted, network adapter communicates with the other components of computer system via bus. It should be understood that although not shown, other hardware and/or software components could be used in conjunction with computer system. Examples include, but are not limited to: microcode, device drivers, redundant processing units, external disk drive arrays, RAID systems, tape drives, and data archival storage systems, etc.

The computer program product may comprise all the respective features enabling the implementation of the methodology described herein, and which—when loaded in a computer system—is able to carry out the methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Various aspects of the present disclosure may be embodied as a program, software, or computer instructions embodied in a computer or machine usable or readable medium, which causes the computer or machine to perform the steps of the method when executed on the computer, processor, and/or machine. A program storage device readable by a machine, tangibly embodying a program of instructions executable by the machine to perform various functionalities and methods described in the present disclosure is also provided.

The system and method of the present disclosure may be implemented and run on a general-purpose computer or special-purpose computer system. The terms “computer system” and “computer network” as may be used in the present application may include a variety of combinations of fixed and/or portable computer hardware, software, peripherals, and storage devices. The computer system may include a plurality of individual components that are networked or otherwise linked to perform collaboratively, or may include one or more stand-alone components. The hardware and software components of the computer system of the present application may include and may be included within fixed and portable devices such as desktop, laptop, and/or server. A module may be a component of a device, software, program, or system that implements some “functionality”, which can be embodied as software, hardware, firmware, electronic circuitry, or etc.

Additionally, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Further, any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Smalltalk, C++ or the like and conventional procedural programming languages, such as the “C” programming language or similar programming languages, a scripting language such as Perl, VBS or similar languages, and/or functional languages such as Lisp and ML and logic-oriented languages such as Prolog. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams as may be illustrated in the one or more Figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The embodiments, features, and instructive examples described above are illustrative, and should not be construed to limit the present disclosure to the particular embodiments or enumerated examples. Thus, various changes and modifications may be effected by one skilled in the art without departing from the spirit or scope of the disclosure as defined in the appended claims.

What is claimed is:

1. A method for managing a group activity using electronic communications, comprising the steps of:
joining a plurality of users to form a proximity based network based on a request from each of the plurality of users, the proximity based network being hosted on a computer and accessible via a communications network;
receiving and accessing data from the plurality of users each using a communications device being configured to communicate with the proximity based network on the communications network, the data including location information and personal information;
defining a predetermined proximity between the communications devices for each of the users;
defining a multiplicity of social connections between the users based on the data;
identifying a set of the plurality of users wherein at least two of the communications devices are within the predetermined proximity, and the corresponding users having a shared social connection;
defining a proposed activity for the set of the users based on the shared social connection; and
notifying the set of users of the proposed activity, wherein at least one of the above steps is performed using a program executable by a processor of a computer.

2. The method of claim 1, further comprising:
notifying the users of the proposed activity by indicating on the users' mobile devices the proposed activity.

3. The method of claim 1, wherein the predetermined proximity is within the same city.

4. The method of claim 1, wherein the step of defining a predetermined proximity includes determining a proximate location in relation to at least one of the users, and the proximate location includes: a city, a town, a radius from a landmark, or a defined land area.

5. The method of claim 1, wherein the notification is selected from a group which includes: an instant message (IM), a short message service (SMS), a post in group chat, and an email.

6. The method of claim 1, further comprising:
providing an activity suggestion service including the steps of claim 1; and
allowing users to register a mobile device for the activity suggestion service.

7. The method of claim 1, wherein the proximity based network is part of a service being accessible by the mobile devices of the plurality of users.

8. The method of claim 1, wherein the shared social connection is selected from a group which includes: a social network connection, an email, instant messages (IM), mutually attending an event, a mutual activity, or a common interest.

9. The method of claim 1, further comprising:
searching within a second predetermined proximity for a location for the proposed activity.

10. A computer program product for managing a group activity using electronic communications, the computer program product comprising a computer readable storage device having program code embodied therewith, the program code being readable/executable by a processor to perform a method, comprising the steps of:
joining a plurality of users to form a proximity based network based on a request from each of the plurality of users, the proximity based network being hosted on a computer and accessible via a communications network;
receiving and accessing data from the plurality of users each using a communications device being configured to communicate with the proximity based network on the communications network, the data including location information and personal information;
defining a predetermined proximity between the communications devices for each of the users;
defining a multiplicity of social connections between the users based on the data;
identifying a set of the plurality of users wherein at least two of the communications devices are within the predetermined proximity, and the corresponding users having a shared social connection;
defining a proposed activity for the set of the users based on the shared social connection; and
notifying the set of users of the proposed activity, wherein at least one of the above steps is performed using a program executable by a processor of a computer.

11. The computer program product of claim 10, further comprising:
notifying the users of the proposed activity by indicating on the users' mobile devices the proposed activity.

12. The computer program product of claim 10, wherein the step of defining a predetermined proximity includes determining a proximate location in relation to at least one of the users, and the proximate location includes: a city, a town, a radius from a landmark, or a defined land area.

13. The computer program product of claim 10, wherein the notification is selected from a group which includes: an instant message (IM), a short message service (SMS), a post in group chat, and an email.

14. The computer program product of claim 10, further comprising:
providing an activity suggestion service including the steps of claim 10; and
allowing users to register a communications device for the activity suggestion service.

15. The computer program product of claim 10, wherein the shared social connection is selected from a group which includes: a social network connection, an email, instant messages (IM), mutually attending an event, a mutual activity, or a common interest.

16. The computer program product of claim 10, further comprising:
searching within a second predetermined proximity for a location for the proposed activity.

17. A system for managing a group activity using electronic communications, comprising:
a communications device being configured to receive and access data from a plurality of users each using a communications device, the communications devices being configured to communicate with a proximity based network on a communications network, the data including location information and personal information, the proximity based network formed using the plurality of users based on a request from each of the plurality of users, and the proximity based network being hosted on a computer and accessible via a communications network;
a computer program embodied on a computer readable storage device and executable by a processor of the computer, the communications device being configured to communicate with the computer, the computer program having program modules having code/instructions for:
defining a predetermined proximity between the communications devices for each of the users;
defining a multiplicity of social connections between the users based on the data;
identifying a set of the plurality of users wherein at least two of the communications devices are within the predetermined proximity, and the corresponding users having a shared social connection;
defining a proposed activity for the set of the users based on the shared social connection; and
notifying the set of users of the proposed activity, wherein at least one of the above steps is performed using a program executable by a processor of a computer.
